(19) United States
(12) Patent Application Publication
(10) Pub. No.: US 2005/0249532 A1
(43) Pub. Date: Nov. 10, 2005

(54) Apparatus and method for applying a load to a fusing nip in a printing machine fuser

(75) Inventors: Steven P. Bailey, Rochester, NY (US); Michael K. Baskin, Springwater, NY (US); Gerard M. Darby II, Brockport, NY (US); Borden H. Mills III, Webster, NY (US); James R. Hendron, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/121,874

(22) Filed: May 4, 2005

Related U.S. Application Data
(60) Provisional application No. 60/568,453, filed on May 5, 2004.

(51) Int. Cl. G03G 15/20

(52) U.S. Cl. 399/328

(57) ABSTRACT

This invention relates in general to fuser for a reproduction apparatus, and more particularly to an adjustable loading mechanism for a printing machine fuser. According to various aspects of the invention, apparatus and methods for loading a printing machine fuser are provided. A loading force for a pressure member and a fuser member may be generated by deflecting a spring relative to a spring support that restrains an end of the spring, the spring support being mounted to an arm body, the arm body comprising a pivot axis and a loading mount acting on one of the pressure member and the fuser member. The loading force may be adjusted by displacing the spring support to adjust a deflection of the spring.

### CROSS REFERENCE TO RELATED APPLICATIONS

This is a 111A application of Provisional Application Ser. No. 60/568,453, filed May 5, 2004, entitled APPARATUS AND METHOD FOR APPLYING A LOAD TO A FUSING NIP IN A PRINTING MACHINE FUSER by Steven P. Bailey, Michael K. Baskin, Gerard M. Darby II, Borden H. Mills III, and James R. Hendron.

### BACKGROUND OF THE INVENTION

This invention relates in general to fuser for a reproduction apparatus, and more particularly to an adjustable loading mechanism for a printing machine fuser.

In typical commercial reproduction apparatus (electrographic copier/duplicators, printers, or the like), a latent image charge pattern is formed on a uniformly charged charge-retentive or photoconductive member having dielectric characteristics (hereinafter referred to as the dielectric support member). Pigmented marking particles are attracted to the latent image charge pattern to develop such image on the dielectric support member. A receiver member, such as a sheet of paper, transparency or other medium, is then brought into contact with the dielectric support member, and an electric field applied to transfer the marking particle developed image to the receiver member from the dielectric support member. After transfer, the receiver member bearing the transferred image is transported away from the dielectric support member, and the image is fixed (fused) to the receiver member by heat and pressure to form a permanent reproduction thereon.

One type of fuser device for typical electrographic reproduction apparatus includes at least one heated roller, having an aluminum core and an elastomeric cover layer, and at least one pressure roller in nip relation with the heated roller. The fuser device rollers are rotated to transport a receiver member, bearing a marking particle image, through the nip between the rollers. The pigmented marking particles of the transferred image on the surface of the receiver member soften and become tacky in the heat. Under the pressure, the softened tacky marking particles attach to each other and are partially imbibed into the interstices of the fibers at the surface of the receiver member. Accordingly, upon cooling, the marking particle image is permanently fixed to the receiver member. In applying pressure to the fusing nip, the pressure may be held within a desired tolerance range in order to achieve adequate fusing without disrupting transport of the receiver member through the fuser device and without damaging the receiver member or the fuser device.

### SUMMARY OF THE INVENTION

According to various aspects of the invention, apparatus and methods for loading a printing machine fuser are provided comprising generating a loading force for a pressure member and a fuser member by deflecting a spring relative to a spring support that restrains an end of the spring, the spring support being mounted to an arm body, the arm body comprising a pivot axis and a loading mount acting on one of the pressure member and the fuser member, and adjusting the loading force by displacing the spring support to adjust a deflection of the spring.

### BRIEF DESCRIPTION OF THE DRAWINGS

FIG. 1 presents a generally schematic side view of a printing machine fuser according one aspect of the invention.

FIG. 2 presents a cross-sectional side view, partly in cross-section of one embodiment of the loading mechanism of FIG. 1.

FIG. 3 presents an end view of an embodiment adapted for adjustment with a tool.

FIG. 4 presents an end view of another embodiment adapted for adjustment with a tool

FIG. 5 presents an end view of another embodiment adapted for adjustment with a tool.

FIG. 6 shows an end view of an embodiment that implements a lever.

FIG. 7 shows a cross-sectional view taken along line 7-7 of FIG. 6.

FIG. 8 shows the cross-sectional view of FIG. 7 with the lever rotated 90°.

FIG. 9 shows a cross-sectional view of another embodiment of the FIG. 1 loading mechanism.

FIG. 10 shows a side view of an embodiment having markings.

### DETAILED DESCRIPTION OF THE INVENTION

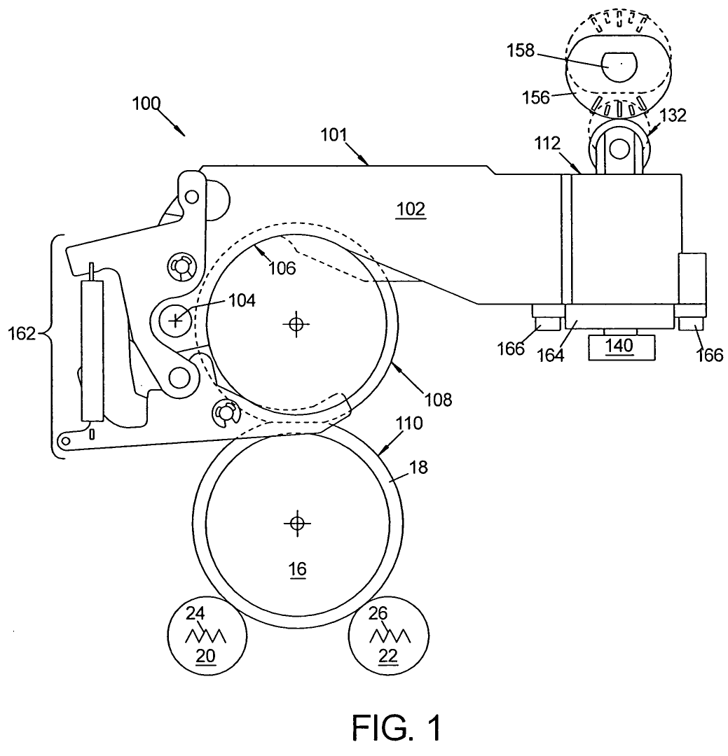

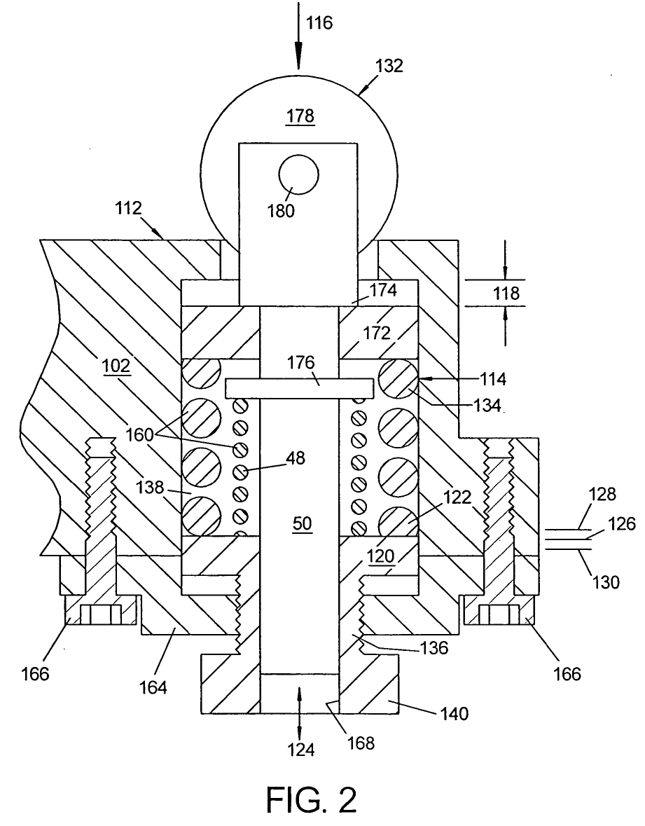

Various aspects of the invention are presented with reference to FIGS. 1-10, which are not drawn to any particular scale, and wherein like components in the various views are numbered alike. Referring now specifically to FIGS. 1 and 2, a printing machine fuser 100 is presented comprising a load arm 101. The arm body 102 has a pivot axis 104, and a loading mount 106 for one of a pressure member 108 and a fuser member 110. The arm body 102 also comprises a loading mechanism 112. The loading mechanism 112 comprises a spring 114 that generates a loading force 116 for the pressure member 108 and the fuser member 104 through a spring deflection 118. A spring support 120 restrains an end 122 of the spring 114, the spring support 120 being mounted to the arm body 102 and displaceable, as shown by arrow 124, to adjust the deflection 118. A cam follower 132 acts on another end 134 of the spring 114 and is mounted to the arm body 102. The cam follower may be actuated by a cam 156 that rotates about a shaft 158 as described in U.S. Pat. No. 6,377,776 issued to Orchard II et al., the contents of which are fully incorporated by reference as if set forth herein. The cam 156 is rotated about the shaft 158 by any suitable motor (not shown) controlled for selective operation by the reproduction apparatus microprocessor based logic and control unit. This disengaged position of the cam 156 is shown in dashed lines in FIG. 1.

The printing machine may be any type of printing machine that may implement a fuser, for example and electrographic copier or printer (including electrophotography) that implements dry or liquid toner, or an inkjet printer, without limitation. As used herein “fuser” and “fusing” refers to apparatus and processes for stabilizing an image on a receiver by heat and/or pressure. The image may be rendered by inkjet, electrographic, or other means that apply marking material to a receiver. The marking material 108 may comprise ink, dye, and/or toner. The particular type of marking material 108 is not critical in the practice of the invention.

According to one aspect of the invention, the spring support 120 is displaceable from one fixed position 126 to another 128 or 130. In such manner, the loading force 116 may be increased or decreased. The spring support 120 comprises a threaded shaft 136 received within the load arm 101 and is displaceable by rotating the threaded shaft 136. More specifically, the load arm may comprise an end cap 164 fastened to the arm body 102 by screws 166, for example, and the threaded shaft 136 may be received within the end cap 164. The load arm 102 may comprise a cavity 138, the spring 114 and the spring support 120 being received within the cavity 138.

The loading mechanism 112 of FIG. 2 comprises a spring nest 160 that operates as described in U.S. Pat. No. 6,587,664 to Baughman et al., the contents of which are incorporated by reference as if fully set forth herein. The spring nest 160 comprises the spring 114 as a heavy spring, and a light spring 48. The springs 114 and 48 are helical compression springs, and may be concentrically supported on the spring support 120 to surround the shaft 50. The light spring 48, and hence the spring nest 160, is optional. A piston 172 acts on the spring 114 (and spring 48, if provided) by a shoulder 174 fixed to the shaft 50. Another shoulder 176 may be provided, fixed to the shaft 50, that acts on spring 48. The cam follower 132 comprises a wheel 178 mounted to the shaft 50 by a pin 180. The cam follower 132 may comprise a bearing.

Total displacement of the spring mount 120 may be limited by a portion 140 engaging an outside surface of the end cap 164 in one direction (in the direction of position 128), and by the spring mount 120 engaging an inside surface of the end cap 164 in an opposite direction (in the direction of position 130). Of course, numerous variations with respect to providing features that limit movement of the spring mount 120 in one direction or another are evident in light of the description provided herein.

As spring support 120 is rotated, the frictional force between the spring support 120 and the spring end 122 may be sufficient to prevent rotation of the spring support 120 during operation of the printing machine fuser 100. This friction force may be intentionally rendered sufficient to prevent the support 120 from rotating when rotation is not desired, for example, to hold the spring support 120 in place after an adjustment.

The load arm 102 may comprise a spring loaded latching mechanism 162 that allows facilitated removal of the pressure member 108 from the load arm 102 without the use of tools. The pressure member 108 may be removed and replaced, with the cam in the unengaged position, for replacement, service, cleaning, etc.

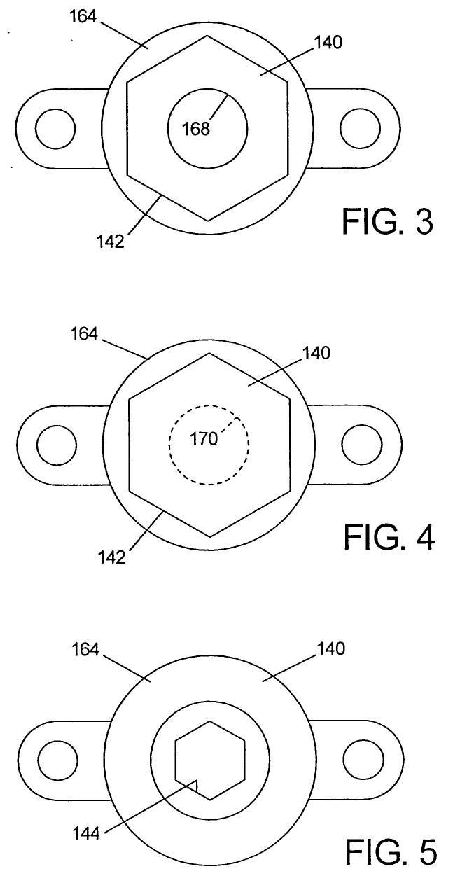

Referring now to FIGS. 3-4, the threaded shaft 136 comprises the portion 140, which may be adapted for gripping, for example by being knurled, or may be adapted for engagement with a tool that assists rotating the threaded shaft 136. In FIGS. 3 and 4, the portion 140 comprises an external hexagonal surface 142 suitable to interface with a wrench such as an open-end or box wrench. In FIG. 3, the portion 140 comprises a through-hole 168 for the shaft 50. In FIG. 4, the portion 140 does not comprise a through-hole, which is permissible if the portion comprises an aperture 170 (shown in dashed lines since it opens to the bottom of the end cap 64) that provides sufficient room for the shaft 50 to move during engagement with the cam 63. In FIG. 5, the portion 140 comprises an internal surface suitable to engage a tool in order to assist rotating the threaded shaft 136, for example an internal hexagonal surface 144 suitable to interface with a hexagonal key wrench (Allen wrench). Other internal surfaces compatible with tools are also suitable, including a slot screwdriver interface, phillips-head screwdriver interface, and a Torx® interface.

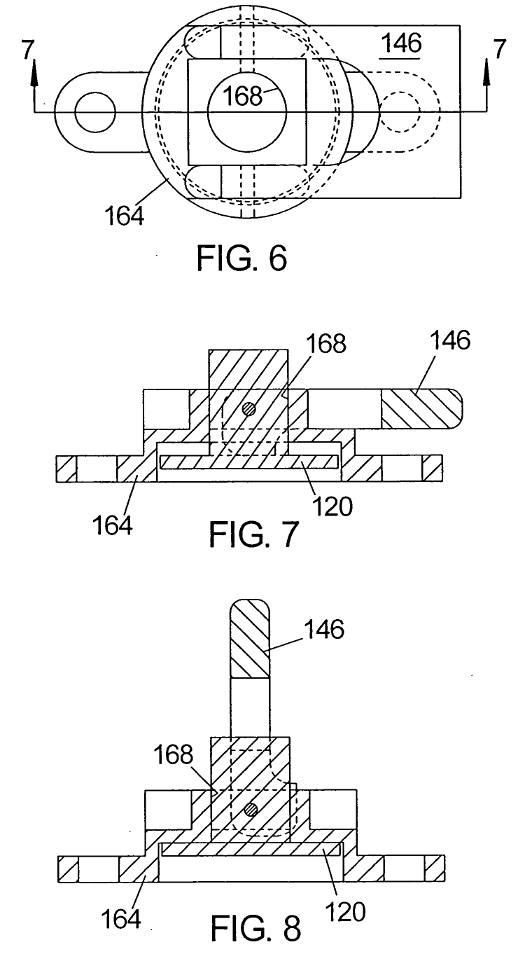

Referring now to FIGS. 6, 7, and 8 the spring support 120 may comprise a lever 146 wherein the spring support 120 is adjustable by rotating the lever 146. FIG. 8 shows the lever rotated 90° from the position of FIG. 7, which enables the spring support 120 to translate from the position shown in FIG. 7 to the position shown in FIG. 8 through a camming arrangement.

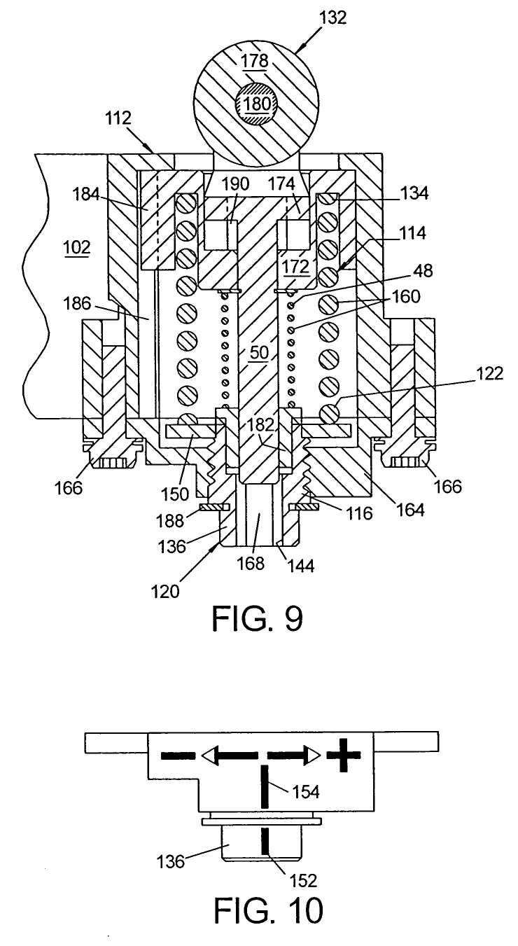

Referring now to FIG. 9, another embodiment of the loading mechanism 112 is presented wherein the spring support 120 comprises a lid 150 press-fit onto the threaded shaft 136. In addition to the components previously discussed with reference to FIG. 2, the embodiment of FIG. 9 comprises a bushing 182 received within the spring support 120, and the shaft 50 is received within the bushing 182. Furthmoremore, the piston 172 may comprise a key 184 that mates with a keyway 186 in the arm body 102. The shoulder 174 may comprise one or two flats 190 with mating flats inside the piston 172. In such manner, the key/keyway 184/186 prevent rotation of the piston 172 relative to the arm body 102, and the flats prevent rotation of the shoulder/cam follower 174/132 relative to the piston 172. An e-ring 188 engages a mating groove in the threaded shaft 136, and acts a limit on adjustment when it contacts the end cap 164. The through-hole 168 is conveniently configured as the internal hexagonal surface 144 and suitable for engagement by a hexagonal key wrench.

Referring now to FIG. 10, the spring support 120 may comprise a mark 152 that indicates rotation of the threaded shaft 136 relative to a fixed mark 154 associated with the load arm 102.

Referring again to FIGS. 1 and 2, a method of loading a printing machine fuser is presented according to a further aspect of the invention comprising generating the 116 loading force for the pressure member 108 and the fuser member 110 by deflecting the spring 114 relative to the spring support 120 that restrains the end of the spring 114, the spring support 120 being mounted to the arm body 102, the arm body 102 comprising the pivot axis 104 and the loading mount 106 acting on one of the pressure member 108 and the fuser member 110, and adjusting the loading force 116 by displacing the spring support 120 to adjust the deflection 118 of the spring 114. In addition to performing these steps with these first components, the method may also comprise deflecting a second spring relative to a second spring support that restrains an end of the second spring, the second spring support being mounted to a second arm body, the second arm body comprising a second pivot axis and a second loading mount acting on one of the pressure member and the fuser member, and adjusting the loading force by displacing the first spring support to adjust a deflection of the first spring, and by displacing the second spring support to adjust a deflection of the second spring. Two load arms 102 are typically disposed on opposite ends of the pressure member 108 or fuser member 110. The first and second load forces may be generated by first and second cams, such as cam 156, as previously described with reference to U.S. Pat. No. 6,377,776.

Nip force may be increased, as disclosed herein, to improve toner adhesion to heavy or thick receiver members. Nip force may be increased or decreased to reduce paper wrinkles or image artifacts with light or thin receiver members. These are intended as examples only, and not as a limit upon potential implementations of the invention.

The second load arm may be a mirror image of the first load arm 102, and may comprise one or more of same components, including a second spring support comprising a second threaded shaft received within the second load arm and a second mark that indicates rotation of the threaded shaft relative to a second fixed mark associated with the second load arm. Adjusting the first and second load arms may comprise displacing the first spring support by rotating the first threaded shaft, and displacing the second spring support by rotating the second threaded shaft.

Referring again to FIG. 1, the fuser member 110 may be a roller in nip relation with the pressure member 108, which may also be a roller. Rotation of the fuser rollers by any suitable drive mechanism (not shown) will serve to transport a receiver member, bearing a marking particle image through the nip under the application of heat and and/or pressure. The receiver member may be a sheet of paper or transparency material for example, or any receiver to which marking particles are fusible, and may be of any width and length. The heat softens the marking particles and the pressure will force the particles into intimate contact with the fibers at the surface of the receiver material. Thus, when the marking particles cool, they are permanently fixed to the receiver member in an image-wise fashion.

The fuser member 110 may include a core 16, for example made of aluminum, and a cylindrical fusing blanket 18 supported on the core. The blanket 18 is typically made of an elastomeric material such as rubber particularly formulated to be heat conductive or heat insulative dependent upon whether the fuser heat source is located within the core 16 or in juxtaposition with the periphery of the blanket. An example of a fuser roller is disclosed in United Patent Application Publication US 2004/0023144 A1, filed Aug. 4, 2003, in the names of Jerry A. Pickering and Alan R. Priebe, the contents of which are incorporated by reference as if fully set forth herein. The pressure member 108 may be similarly constructed, for example a metallic core (such as aluminum) covered by an elastomeric cushion (such as filled silicone elastomer), covered by a PFA or Teflon® (tetrafluoroethylene) plastic sleeve.

A well known suitable surface coating, for example silicone oil, (not shown) may be applied to the blanket 18 to substantially prevent offsetting of the marking particle image to the fuser member 110. A heat source for the fuser member 110 is a pair of external heater rollers, respectively designated by the numerals 20, 22, having internal heater lamps 24, 26. The fuser roller is cradled between the two heater rollers 20, 22, and heat is applied to the fuser member 110 from the internally heated heater rollers 20,22. Typically the surface of fuser member 110 is heated to a temperature from about 330 to about 385° F. The use of the oil as discussed above is effective with silicone rubbers and will be useful with other materials, as is well known to those skilled in the art. As mentioned above, the surface treatment is typically silicone oil having a viscosity between 100 and 100,000 centistokes at 70° F. A suitable oil is marketed under the trademark DC 200 by Dow Corning, Midland, Mich. A typical additive for use with such oils is marketed under the trademark SILWET by Union Carbide Corporation, Old Ridgebury Road, Danbury, Conn. Pertinent information regarding surface treatment applicators is disclosed in U.S. Pat. Nos. 5,235,394, 5,267,004 and 5,732,317, the contents of which are fully incorporated by reference as if set forth herein.

In a certain embodiment, the target for the fuser nip force is 367 pounds. Target nip force adjustment range is between 335 pounds and 400 pounds. Spring rate of spring 114 is 98 pounds per inch and there are 2 springs, one for each of two load arms 101. Mechanical advantage provided by the load arms 101 is 3.66 to 1. Thus, the target adjustment distance is 65/(98×2×3.66)=0.091 inches. This is achieved by an adjustment screw with a pitch of 11. Thus, a single turn of both front and rear adjustment screws provides 65 pounds of nip force adjustment.

The concepts described herein are equally applicable to other fuser configurations, such as a fuser belt. A fuser belt system is disclosed in U.S. Pat. No. 6,096,427 issued Aug. 1, 2000 to Chen et al. This patent is hereby incorporated in its entirety by reference as if fully set for herein.

A web cleaning assembly as disclosed in U.S. Pat. No. 6,631,251 may be implemented to clean the fuser member 110, the contents of which are hereby incorporated by reference as if fully set forth herein. The web cleaning assembly is pivotably mounted to a slide in the fuser section of the apparatus whereby the assembly can be slid out of the fuser section and then rotated to a service position where the assembly is releasably latched while the supply and take-up rollers within the web cleaning assembly are removed and replaced. Furthermore, the pressure member 108 may be cleaned with a cleaning pad mounted adjacent the pressure roller in an electrographic printer, as described in co-pending U.S. patent application Ser. No. 10/669,077 filed Sep. 23, 2003, entitled “Method and Apparatus for Cleaning a Pressure Roll in a Fusing Station”, the contents of which are hereby incorporated by reference as if fully set forth herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements have been described as being implemented by software, in other embodiments hardware or firmware implementations may alternatively be used, and vice-versa. Similarly, the controllers may implement software, hardware, and/or firmware. In view of the wide variety of embodiments to which the principles of the present invention can be applied, it should be understood that the illustrated embodiments are exemplary only, and should not be taken as limiting the scope of the present invention.

The claims should not be read as limited to the described order or elements unless stated to that effect. In addition, use of the term “means” in any claim is intended to invoke 35 U.S.C. §112, paragraph 6, and any claim without the word “means” is not so intended.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

1. A load arm for a printing machine fuser, comprising:
an arm body having a pivot axis;
a loading mount for one of a pressure member and a fuser member;
a spring that generates a loading force for the pressure member and the fuser member through a spring deflection; and
a spring support that restrains an end of the spring, the spring support being mounted to the arm body and displaceable to adjust the deflection.

2. The load arm of claim 1, the spring support being displaceable from one fixed position to another.

3. The load arm of claim 1, comprising a cam follower that acts on another end of the spring and mounted to the arm body.

4. The load arm of claim 1, the load arm comprising a cavity, the spring and the spring support being received within the cavity.

5. The load arm of claim 1, the spring support comprising a threaded shaft received within the load arm and being displaceable by rotating the threaded shaft.

6. The load arm of claim 1, the spring support comprising a threaded shaft received within the load arm and being displaceable by rotating the threaded shaft, the threaded shaft comprising a portion adapted for engagement with a tool that assists rotating the threaded shaft.

7. The load arm of claim 1, the spring support comprising a threaded shaft received within the load arm and being displaceable by rotating the threaded shaft, the threaded shaft comprising an internal surface adapted for engagement with a tool that assists rotating the threaded shaft.

8. The load arm of claim 1, the spring support comprising a threaded shaft received within the load arm and being displaceable by rotating the threaded shaft, and a lid press-fit onto the threaded shaft upon which the spring rests.

9. The load arm of claim 1, the spring support comprising a threaded shaft received within the load arm and being displaceable by rotating the threaded shaft and comprising a mark that indicates rotation of the threaded shaft relative to a fixed mark associated with the load arm.

10. The load arm of claim 1, the spring support comprising a lever wherein the spring support is adjustable by rotating the lever.

11. A method of loading a printing machine fuser, comprising:
generating a loading force for a pressure member and a fuser member by deflecting a spring relative to a spring support that restrains an end of the spring, the spring support being mounted to an arm body, the arm body comprising a pivot axis and a loading mount acting on one of the pressure member and the fuser member; and
adjusting the loading force by displacing the spring support to adjust a deflection of the spring.

12. The method of claim 11, comprising displacing the spring support from one fixed position to another.

13. The method of claim 11, comprising a cam follower that acts on another end of the spring and mounted to the arm body.

14. The method of claim 11, the load arm comprising a cavity, the spring and the spring support being received within the cavity.

15. The method of claim 11, the spring support comprising a threaded shaft received within the load arm and displacing the spring support by rotating the threaded shaft.

16. The method of claim 11, the spring support comprising a threaded shaft received within the load arm and displacing the spring support by rotating the threaded shaft, the threaded shaft comprising a portion adapted for engagement with a tool that assists rotating the threaded shaft.

17. The method of claim 11, the spring support comprising a threaded shaft received within the load arm and displacing the spring support by rotating the threaded shaft, the threaded shaft comprising an internal surface adapted for engagement with a tool that assists rotating the threaded shaft.

18. The method of claim 11, the spring support comprising a threaded shaft received within the load arm and displacing the spring support by rotating the threaded shaft, and a lid press-fit onto the threaded shaft upon which the spring rests.

19. The method of claim 11, the spring support comprising a threaded shaft received within the load arm and displacing the spring support by rotating the threaded shaft and comprising a mark that indicates rotation of the threaded shaft relative to a fixed mark associated with the load arm.

20. The method of claim 11, the spring support comprising a lever wherein the spring support and adjusting the spring support by rotating the lever.

21. A method of loading a printing machine fuser, comprising:
generating a loading force for a pressure member and a fuser member by
(a) deflecting a first spring relative to a first spring support that restrains an end of the first spring, the first spring support being mounted to a first arm body, the first arm body comprising a first pivot axis and a first loading mount acting on one of the pressure member and the fuser member, and
(b) deflecting a second spring relative to a second spring support that restrains an end of the second spring, the second spring support being mounted to a second arm body, the second arm body comprising a second pivot axis and a second loading mount acting on one of the pressure member and the fuser member; and
adjusting the loading force by displacing the first spring support to adjust a deflection of the first spring, and by displacing the second spring support to adjust a deflection of the second spring.

22. The method of claim 21, the first spring support comprising a first threaded shaft received within the first load arm and a first mark that indicates rotation of the threaded shaft relative to a first fixed mark associated with the first load arm;
the second spring support comprising a second threaded shaft received within the second load arm and a second mark that indicates rotation of the threaded shaft relative to a second fixed mark associated with the second load arm;
displacing the first spring support by rotating the first threaded shaft; and
displacing the second spring support by rotating the second threaded shaft.
